(19) United States
(12) Patent Application Publication
(10) Pub. No.: US 2008/0134189 A1
(43) Pub. Date: Jun. 5, 2008

(54) Job scheduling amongst multiple computers

(76) Inventor: John M. Holt, Essex (GB)

Correspondence Address: PERKINS COIE LLP, P.O. BOX 2168, MENLO PARK, CA, 94026, US

(21) Appl. No.: 11/973,329

(22) Filed: Oct. 5, 2007

Related U.S. Application Data
(60) Provisional application No. 60/850,503, filed on Oct. 9, 2006.
(60) Provisional application No. 60/850,537, filed on Oct. 9, 2006.

(30) Foreign Application Priority Data
Oct. 5, 2006 (AU) 2006 905 528
Oct. 5, 2006 (AU) 2006 905 534

(51) Int. Cl. G06F 15/16; G06F 9/46

(52) U.S. Cl. 718/102; 718/100; 709/201

(57) ABSTRACT

A multiple computer system is disclosed in which each computer (M1, M2, Mn, Mn+1) operates a different portion of an application program (15) written to be executed on only a single computer, said computers being interconnected via a communications network (53). An instruction such as “new thread ( )” which creates an additional thread (Tm+1) is not created on a computer (Mn) including that instruction and existing operating thread Tm. Instead the instruction is intercepted or detected and passed to another machine (Mn+1) which creates the additional thread (Tm+1). Preferably the computers (Mn) and (Mn+1) are adjacent computers in a closed loop of consecutively numbered computers.

### CROSS-REFERENCE TO RELATED APPLICATIONS

The present application claims the benefit of priority to U.S. Provisional Application Nos. 60/850,503 (5027BK-US) and 60/850,537 (5027Y-US), both filed 9 Oct. 2006; and to Australian Provisional Application Nos. 2006 905 528 (5027BK-AU) and 2006 905 534 (5027Y-AU), both filed on 5 Oct. 2006, each of which are hereby incorporated herein by reference.

This application is related to concurrently filed U.S. application entitled “Job Scheduling Amongst Multiple Computers,” (Attorney Docket No. 61130-8030.US02 (5027BK-US02)) which is hereby incorporated herein by reference.

### FIELD OF THE INVENTION

The present invention relates to computing and, in particular, to computing utilizing multiple threads. The present invention finds particular application to the simultaneous operation of a plurality of computers interconnected via a communications network.

### BACKGROUND

International Patent Application No. PCT/AU2005/000580 (Attorney Ref 5027F-WO) published under WO 2005/103926 (to which U.S. patent application Ser. No. 11/111,946 and published under No. 2005-0262313 corresponds) in the name of the present applicant, discloses how different portions of an application program written to execute on only a single computer can be operated substantially simultaneously on a corresponding different one of a plurality of computers. That simultaneous operation has not been commercially used as of the priority date of the present application. International Patent Application Nos. PCT/AU2005/001641 (WO2006/110937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO2006/110957) (Attorney Ref: 5027F-D2-WO) both in the name of the present applicant and both unpublished as at the priority date of the present application, also disclose further details. Furthermore, International Patent Application No. PCT/AU2007/ . . . which is lodged simultaneously herewith entitled “Hybrid Replicated Shared Memory Architecture” and claims priority from Australian patent application No. 2006 905 534 (Attorney Ref 5027Y-WO) to which U.S. patent application No. 60/850,537 corresponds, discloses that it is not necessary to replicate all memory locations on all computers. The contents of the specification of each of the abovementioned prior application(s) are hereby incorporated into the present specification by cross reference for all purposes.

Briefly stated, the abovementioned patent specifications disclose that at least one application program written to be operated on only a single computer can be simultaneously operated on a number of computers each with independent local memory. The memory locations required for the operation of that program are replicated in the independent local memory of each computer. On each occasion on which the application program writes new data to any replicated memory location, that new data is transmitted and stored at each corresponding memory location of each computer. Thus apart from the possibility of transmission delays, each computer has a local memory the contents of which are substantially identical to the local memory of each other computer and are updated to remain so. Since all application programs, in general, read data much more frequently than they cause new data to be written, the abovementioned arrangement enables very substantial advantages in computing speed to be achieved. In particular, the stratagem enables two or more commodity computers interconnected by a commodity communications network to be operated simultaneously running under the application program written to be executed on only a single computer.

### GENESIS OF THE INVENTION

In many situations, the above-mentioned arrangements work satisfactorily, however it is desirable to balance the computational load amongst the various computers. It is towards spreading the computational load that the present invention is directed.

### SUMMARY OF THE INVENTION

In accordance with a first aspect of the present invention there is disclosed in a multiple computer environment in which a plurality of computers each having an independent local memory are each able to execute a different portion of an application program written to be executed on only a single computer and are each interconnected by means of a communications network, the improvement comprising the steps of:

(i) intercepting or detecting an instruction or operation to create an additional thread about to be executed by the portion of said application program executing on one of said computers,
(ii) preventing said one computer from creating said additional thread,
(iii) instructing another one of said plurality of computers to create said additional thread, and
(iv) creating said additional thread on said another computer.

In accordance with a second aspect of the present invention there is disclosed a multiple computer system in which a plurality of computers each having an independent local memory, and each being able to execute a different portion of an application program written to be executed on only a single computer, said plurality of computers each being interconnected via a communications network, wherein each said computer includes intercepting or detecting means to intercept or detect an instruction to create an additional thread about to be executed by the portion of said application program executing on that computer and prevent said additional thread from being created on that computer, and each said computer includes routing means to pass said thread creating instruction to another one of said plurality of computers on which said additional thread is created.

### BRIEF DESCRIPTION OF THE DRAWINGS

A preferred embodiment of the present invention will now be described with reference to the drawings in which:

FIG. 1 is a schematic representation of a single computer known in the prior art and running an application program,

FIG. 2 is a schematic representation of how a single prior art computer creates an additional thread,

FIG. 3 is a schematic diagram of three computers operating under the prior art DSM,

FIG. 4A is a schematic illustration of a prior art computer arranged to operate JAVA code and thereby constitute a single JAVA virtual machine,

FIG. 4B is a drawing similar to FIG. 4A but illustrating the initial loading of code,

FIG. 4C illustrates the interconnection of a multiplicity of computers each being a JAVA virtual machine to form a multiple computer system,

FIG. 5 schematically illustrates “n” application running computers to which at least one additional server machine X is connected as a server,

FIG. 5A is a schematic representation of an RSM multiple computer system,

FIG. 5B is a similar schematic representation of a partial or hybrid RSM multiple computer system,

FIG. 6 is a schematic representation of the preferred multi-computer arrangement of preferred embodiment of the present invention, and

FIG. 7 is a representation of two of the computers of FIG. 6 showing how an additional thread is created on another computer.

### DETAILED DESCRIPTION

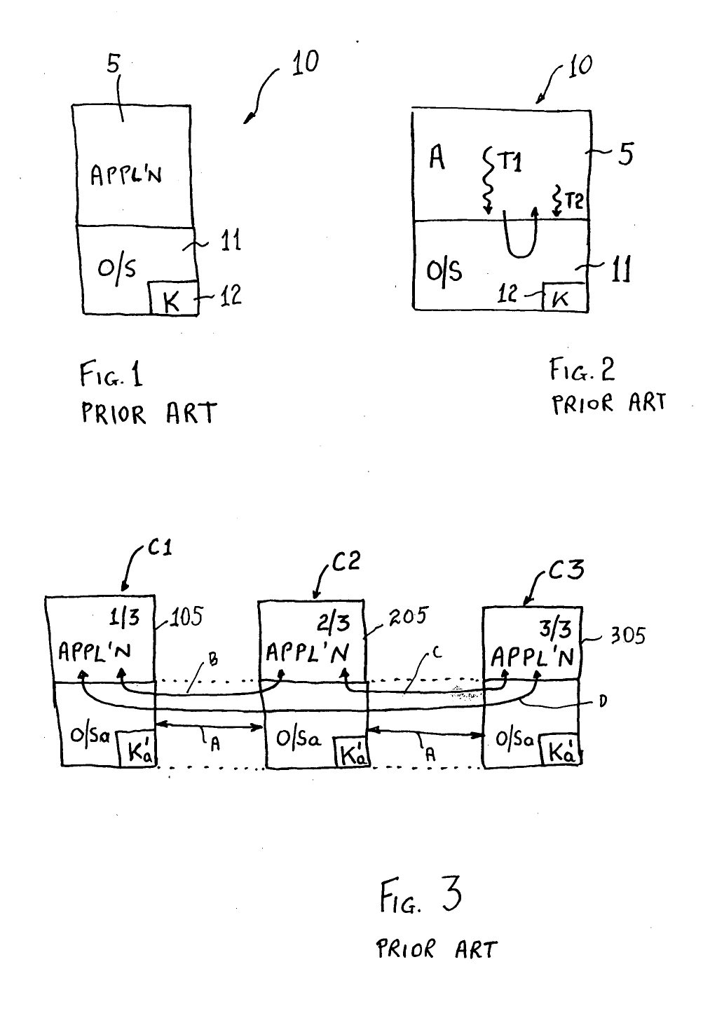

As seen in FIG. 1, an individual computer 10 has an operating system 11 which includes a kernel 12. In particular, the operating system 11 is unmodified and is as supplied by the vendor and thus is regarded as being a TCB (ie a trusted computing base). This means that the purchaser has various operational guarantees and a satisfactory performance by the computer 10 is to be expected.

Running on the computer 10 is an application program 5 which is what the user sees when the computer 10 is operated. In this sense the operation of the operating system 11 is essentially invisible to the user.

The abovementioned prior art arrangement works satisfactorily provided that the computational demands of the application program 5 do not exceed the capacity of the computer 10. In the event that this occurs, the user is obliged to migrate to a multiple computer system.

Turning now to FIG. 2, in the prior art arrangement of a single computer, during the execution of the application program 5, the application program can call for the creation of a new thread. For example, in the arrangement illustrated in FIG. 2 where a single thread T1 is operating, a second new and parallel thread T2 is desired to be created. In the JAVA environment the creation of the new thread is created by means of the JAVA instruction “new thread ( )”. Other languages have equivalent instructions.

The effect of the instruction “new thread ( )” is that the operating system (O/S) 11 creates the new thread T2 which is then available to the application program 5 for simultaneous operation together with the pre-existing thread T1.

The typical commercially available multiple computer system is illustrated in FIG. 3 and is known as Distributed Shared Memory (DSM). In the example illustrated in FIG. 3 there are three identical computers C1, C2, and C3 each of which has an identical operating system O/Sa which includes a modified kernel Ka′. As indicated by arrows A in FIG. 2, the three operating systems O/Sa are able to communicate with each other and, as indicated by dotted lines in FIG. 2, the three computers effectively see a single operating system.

However, in this effective single operating system the kernels have been modified relative to the kernel 12 of FIG. 1 and this modification means that the arrangement illustrated in FIG. 2 may, by some users, be no longer considered a TCB.

Furthermore, the application program has three approximately equal portions 105, 205 and 305, a different one of which is present on each of the computers C1, C2, and C3 respectively. As indicated by arrows B, C, and D in FIG. 3, each portion 105, 205, 305 of the application program 5 is able to communicate with each other portion of the application program.

There are two significant disadvantages with the arrangement of FIG. 3. The first is that each of the computers C1, C, and C3 must be identical. Therefore if the user of the single computer of FIG. 1 is unable to purchase two further identical computers 10, (for example because that particular model has gone out of production), then it becomes necessary for the user to purchase three new computers in order to “upgrade” to a multiple computer system having three computers, and not merely two additional computers.

In addition, in the arrangement of FIGS. 1 and 2, the kernel 12 keeps track of each of the threads (T1, T2, etc) of the computer 10 which are executing the application program 5. Similarly, in the arrangement of FIG. 3, each of the three kernels Ka′ keeps track of all threads of all three machines. As a consequence, the limit of the number of threads able to be successfully manipulated by the kernels is rapidly exceeded as the number of machines increases and/or the computational difficulty of the application program portions 105, 205, and 305 increases.

Furthermore, another disadvantage of the prior art DSM system of FIG. 3 is that since the operating systems share threads and resources, in the event that one of the computers C1-C3 fails, the entire system fails.

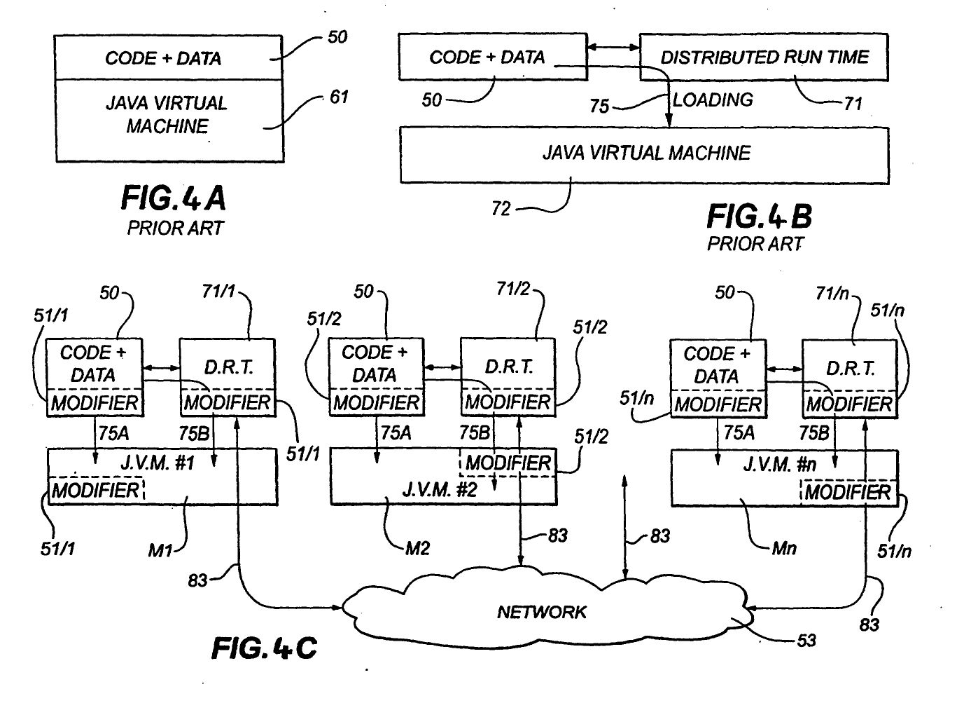

The description of FIGS. 4A-4C will be with reference to the JAVA language, however, it will be apparent to those skilled in the art that the invention is not limited to this language and, in particular can be used with other languages (including procedural, declarative and object oriented languages) including the MICROSOFT.NET platform and architecture (Visual Basic, Visual C, and Visual C++, and Visual C#), FORTRAN, C, C++, COBOL, BASIC and the like.

It is known in the prior art to provide a single computer or machine (produced by any one of various manufacturers and having an operating system (or equivalent control software or other mechanism) operating in any one of various different languages) utilizing the particular language of the application by creating a virtual machine as illustrated in FIG. 4A.

The code and data and virtual machine configuration or arrangement of FIG. 4A takes the form of the application code 50 written in the JAVA language and executing within the JAVA virtual machine 61. Thus where the intended language of the application is the language JAVA, a JAVA virtual machine is used which is able to operate code in JAVA irrespective of the machine manufacturer and internal details of the computer or machine. For further details, see “The JAVA Virtual Machine Specification” 2^{nd} Edition by T. Lindholm and F. Yellin of Sun Microsystems Inc of the USA which is incorporated herein by reference.

This conventional art arrangement of FIG. 4A is modified in by the present applicant by the provision of an additional facility which is conveniently termed a “distributed run time” or a “distributed run time system” DRT 71 and as seen in FIG. 4B.

In FIGS. 4B and 4C, the application code 50 is loaded onto the Java Virtual Machine(s) M1, M2, . . . Mn in cooperation with the distributed runtime system 71, through the loading procedure indicated by arrow 75 or 75A or 75B. As used herein the terms “distributed runtime” and the “distributed run time system” are essentially synonymous, and by means of illustration but not limitation are generally understood to include library code and processes which support software written in a particular language running on a particular platform. Additionally, a distributed runtime system may also include library code and processes which support software written in a particular language running within a particular distributed computing environment. A runtime system (whether a distributed runtime system or not) typically deals with the details of the interface between the program and the operating system such as system calls, program start-up and termination, and memory management. For purposes of background, a conventional Distributed Computing Environment (DCE) (that does not provide the capabilities of the inventive distributed run time or distributed run time system 71 used in the preferred embodiments of the present invention) is available from the Open Software Foundation. This Distributed Computing Environment (DCE) performs a form of computer-to-computer communication for software running on the machines, but among its many limitations, it is not able to implement the desired modification or communication operations. Among its functions and operations the preferred DRT 71 coordinates the particular communications between the plurality of machines M1, M2, . . . Mn. Moreover, the preferred distributed runtime 71 comes into operation during the loading procedure indicated by arrow 75A or 75B of the JAVA application 50 on each JAVA virtual machine 72 or machines JVM#1, JVM#2, . . . JVM#n of FIG. 1C. It will be appreciated in light of the description provided herein that although many examples and descriptions are provided relative to the JAVA language and JAVA virtual machines so that the reader may get the benefit of specific examples, there is no restriction to either the JAVA language or JAVA virtual machines, or to any other language, virtual machine, machine or operating environment.

FIG. 4C shows in modified form the arrangement of the JAVA virtual machines, each as illustrated in FIG. 4B. It will be apparent that again the same application code 50 is loaded onto each machine M1, M2 . . . Mn. However, the communications between each machine M1, M2 . . . Mn are as indicated by arrows 83, and although physically routed through the machine hardware, are advantageously controlled by the individual DRT's 71/1 . . . 71/n within each machine. Thus, in practice this may be conceptionalised as the DRT's 71/1, . . . 71/n communicating with each other via the network or other communications link 53 rather than the machines M1, M2 . . . Mn communicating directly themselves or with each other. Contemplated and included are either this direct communication between machines M1, M2 . . . Mn or DRT's 71/1, 71/2 . . . 71/n or a combination of such communications. The preferred DRT 71 provides communication that is transport, protocol, and link independent.

The one common application program or application code 50 and its executable version (with likely modification) is simultaneously or concurrently executing across the plurality of computers or machines M1, M2 . . . Mn. The application program 50 is written to execute on a single machine or computer (or to operate on the multiple computer system of the abovementioned patent applications which emulate single computer operation). Essentially the modified structure is to replicate an identical memory structure and contents on each of the individual machines.

The term “common application program” is to be understood to mean an application program or application program code written to operate on a single machine, and loaded and/or executed in whole or in part on each one of the plurality of computers or machines M1, M2. Mn, or optionally on each one of some subset of the plurality of computers or machines M1, M2 . . . Mn. Put somewhat differently, there is a common application program represented in application code 50. This is either a single copy or a plurality of identical copies each individually modified to generate a modified copy or version of the application program or program code. Each copy or instance is then prepared for execution on the corresponding machine. At the point after they are modified they are common in the sense that they perform similar operations and operate consistently and coherently with each other. It will be appreciated that a plurality of computers, machines, information appliances, or the like implementing the above arrangements may optionally be connected to or coupled with other computers, machines, information appliances, or the like that do not implement the above arrangements.

The same application program 50 (such as for example a parallel merge sort, or a computational fluid dynamics application or a data mining application) is run on each machine, but the executable code of that application program is modified on each machine as necessary such that each executing instance (copy or replica) on each machine coordinates its local operations on that particular machine with the operations of the respective instances (or copies or replicas) on the other machines such that they function together in a consistent, coherent and coordinated manner and give the appearance of being one global instance of the application (i.e. a “meta-application”).

The copies or replicas of the same or substantially the same application codes, are each loaded onto a corresponding one of the interoperating and connected machines or computers. As the characteristics of each machine or computer may differ, the application code 50 may be modified before loading, or during the loading process, or with some disadvantages after the loading process, to provide a customization or modification of the application code on each machine. Some dissimilarity between the programs or application codes on the different machines may be permitted so long as the other requirements for interoperability, consistency, and coherency as described herein can be maintained. As it will become apparent hereafter, each of the machines M1, M2 . . . Mn and thus all of the machines M1, M2 . . . Mn have the same or substantially the same application code 50, usually with a modification that may be machine specific.

Before the loading of, or during the loading of, or at any time preceding the execution of, the application code 50 (or the relevant portion thereof) on each machine M1, M2 . . . Mn, each application code 50 is modified by a corresponding modifier 51 according to the same rules (or substantially the same rules since minor optimizing changes are permitted within each modifier 51/1, 51/2 . . . 51/n).

Each of the machines M1, M2 . . . Mn operates with the same (or substantially the same or similar) modifier 51 (in some embodiments implemented as a distributed run time or DRT71 and in other embodiments implemented as an adjunct to the application code and data 50, and also able to be implemented within the JAVA virtual machine itself). Thus all of the machines M1, M2 . . . Mn have the same (or substantially the same or similar) modifier 51 for each modification required. A different modification, for example, may be required for memory management and replication, for initialization, for finalization, and/or for synchronization (though not all of these modification types may be required for all embodiments).

There are alternative implementations of the modifier 51 and the distributed run time 71. For example, as indicated by broken lines in FIG. 4C, the modifier 51 may be implemented as a component of or within the distributed run time 71, and therefore the DRT 71 may implement the functions and operations of the modifier 51. Alternatively, the function and operation of the modifier 51 may be implemented outside of the structure, software, firmware, or other means used to implement the DRT 71 such as within the code and data 50, or within the JAVA virtual machine itself. In one embodiment, both the modifier 51 and DRT 71 are implemented or written in a single piece of computer program code that provides the functions of the DRT and modifier. In this case the modifier function and structure is, in practice, subsumed into the DRT. Independent of how it is implemented, the modifier function and structure is responsible for modifying the executable code of the application code program, and the distributed run time function and structure is responsible for implementing communications between and among the computers or machines. The communications functionality in one embodiment is implemented via an intermediary protocol layer within the computer program code of the DRT on each machine. The DRT can, for example, implement a communications stack in the JAVA language and use the Transmission Control Protocol/Internet Protocol (TCP/IP) to provide for communications or talking between the machines. These functions or operations may be implemented in a variety of ways, and it will be appreciated in light of the description provided herein that exactly how these functions or operations are implemented or divided between structural and/or procedural elements, or between computer program code or data structures, is not important or crucial.

However, in the arrangement illustrated in FIG. 4C, a plurality of individual computers or machines M1, M2 . . . Mn are provided, each of which are interconnected via a communications network 53 or other communications link. Each individual computer or machine is provided with a corresponding modifier 51. Each individual computer is also provided with a communications port which connects to the communications network. The communications network 53 or path can be any electronic signalling, data, or digital communications network or path and is preferably a slow speed, and thus low cost, communications path, such as a network connection over the Internet or any common networking configurations including ETHERNET or INFINIBAND and extensions and improvements, thereto. Preferably, the computers are provided with one or more known communications ports (such as CISCO Power Connect 5224 Switches) which connect with the communications network 53.

As a consequence of the above described arrangement, if each of the machines M1, M2, . . . , Mn has, say, an internal or local memory capability of 10 MB, then the total memory available to the application code 50 in its entirety is not, as one might expect, the number of machines (n) times 10 MB. Nor is it the additive combination of the internal memory capability of all n machines. Instead it is either 10 MB, or some number greater than 10 MB but less than n×10 MB. In the situation where the internal memory capacities of the machines are different, which is permissible, then in the case where the internal memory in one machine is smaller than the internal memory capability of at least one other of the machines, then the size of the smallest memory of any of the machines may be used as the maximum memory capacity of the machines when such memory (or a portion thereof) is to be treated as ‘common’ memory (i.e. similar equivalent memory on each of the machines M1 . . . Mn) or otherwise used to execute the common application code.

However, even though the manner that the internal memory of each machine is treated may initially appear to be a possible constraint on performance, how this results in improved operation and performance will become apparent hereafter. Naturally, each machine M1, M2 . . . Mn has a private (i.e. ‘non-common’) internal memory capability. The private internal memory capability of the machines M1, M2, . . . , Mn are normally approximately equal but need not be. For example, when a multiple computer system is implemented or organized using existing computers, machines, or information appliances, owned or operated by different entities, the internal memory capabilities may be quite different. On the other hand, if a new multiple computer system is being implemented, each machine or computer is preferably selected to have an identical internal memory capability, but this need not be so.

It is to be understood that the independent local memory of each machine represents only that part of the machine's total memory which is allocated to that portion of the application program running on that machine. Thus, other memory will be occupied by the machine's operating system and other computational tasks unrelated to the application program 50.

Non-commercial operation of a prototype multiple computer system indicates that not every machine or computer in the system utilises or needs to refer to (e.g. have a local replica of) every possible memory location. As a consequence, it is possible to operate a multiple computer system without the local memory of each machine being identical to every other machine, so long as the local memory of each machine is sufficient for the operation of that machine. That is to say, provided a particular machine does not need to refer to (for example have a local replica of) some specific memory locations, then it does not matter that those specific memory locations are not replicated in that particular machine.

It may also be advantageous to select the amounts of internal memory in each machine to achieve a desired performance level in each machine and across a constellation or network of connected or coupled plurality of machines, computers, or information appliances M1, M2, . . . , Mn. Having described these internal and common memory considerations, it will be apparent in light of the description provided herein that the amount of memory that can be common between machines is not a limitation.

In some embodiments, some or all of the plurality of individual computers or machines can be contained within a single housing or chassis (such as so-called “blade servers” manufactured by Hewlett-Packard Development Company, Intel Corporation, IBM Corporation and others) or the multiple processors (eg symmetric multiple processors or SMPs) or multiple core processors (eg dual core processors and chip multithreading processors) manufactured by Intel, AMD, or others, or implemented on a single printed circuit board or even within a single chip or chipset. Similarly, also included are computers or machines having multiple cores, multiple CPU's or other processing logic.

When implemented in a non-JAVA language or application code environment, the generalized platform, and/or virtual machine and/or machine and/or runtime system is able to operate application code 50 in the language(s) (possibly including for example, but not limited to any one or more of source-code languages, intermediate-code languages, object-code languages, machine-code languages, and any other code languages) of that platform and/or virtual machine and/or machine and/or runtime system environment, and utilize the platform, and/or virtual machine and/or machine and/or runtime system and/or language architecture irrespective of the machine or processor manufacturer and the internal details of the machine. It will also be appreciated that the platform and/or runtime system can include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the structure, method and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the Power PC computer architecture manufactured by International Business Machines Corporation and others, and the personal computer products made by Apple Computer, Inc., and others.

For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records), derived types, or other code or data structures of procedural languages or other languages and environments such as functions, pointers, components, modules, structures, reference and unions. These structures and procedures when applied in combination when required, maintain a computing environment where memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

This analysis or scrutiny of the application code 50 can take place either prior to loading the application program code 50, or during the application program code 50 loading procedure, or even after the application program code 50 loading procedure (or some combination of these). It may be likened to an instrumentation, program transformation, translation, or compilation procedure in that the application code can be instrumented with additional instructions, and/or otherwise modified by meaning-preserving program manipulations, and/or optionally translated from an input code language to a different code language (such as for example from source-code language or intermediate-code language to object-code language or machine-code language). In this connection it is understood that the term “compilation” normally or conventionally involves a change in code or language, for example, from source code to object code or from one language to another language. However, in the present instance the term “compilation” (and its grammatical equivalents) is not so restricted and can also include or embrace modifications within the same code or language. For example, the compilation and its equivalents are understood to encompass both ordinary compilation (such as for example by way of illustration but not limitation, from source-code to object code), and compilation from source-code to source-code, as well as compilation from object-code to object code, and any altered combinations therein. It is also inclusive of so-called “intermediary-code languages” which are a form of “pseudo object-code”.

By way of illustration and not limitation, in one arrangement, the analysis or scrutiny of the application code 50 takes place during the loading of the application program code such as by the operating system reading the application code 50 from the hard disk or other storage device, medium or source and copying it into memory and preparing to begin execution of the application program code. In another arrangement, in a JAVA virtual machine, the analysis or scrutiny may take place during the class loading procedure of the java.lang.ClassLoader.loadClass method (e.g. “java.lang.ClassLoader.loadClass( )”).

Alternatively, or additionally, the analysis or scrutiny of the application code 50 (or of a portion of the application code) may take place even after the application program code loading procedure, such as after the operating system has loaded the application code into memory, or optionally even after execution of the relevant corresponding portion of the application program code has started, such as for example after the JAVA virtual machine has loaded the application code into the virtual machine via the “java.lang.ClassLoader.loadClass( )” method and optionally commenced execution.

Persons skilled in the computing arts will be aware of various possible techniques that may be used in the modification of computer code, including but not limited to instrumentation, program transformation, translation, or compilation means and/or methods.

One such technique is to make the modification(s) to the application code, without a preceding or consequential change of the language of the application code. Another such technique is to convert the original code (for example, JAVA language source-code) into an intermediate representation (or intermediate-code language, or pseudo code), such as JAVA byte code. Once this conversion takes place the modification is made to the byte code and then the conversion may be reversed. This gives the desired result of modified JAVA code.

A further possible technique is to convert the application program to machine code, either directly from source-code or via the abovementioned intermediate language or through some other intermediate means. Then the machine code is modified before being loaded and executed. A still further such technique is to convert the original code to an intermediate representation, which is thus modified and subsequently converted into machine code. All such modification routes are envisaged and also a combination of two, three or even more, of such routes.

The DRT 71 or other code modifying means is responsible for creating or replicating a memory structure and contents on each of the individual machines M1, M2 . . . Mn that permits the plurality of machines to interoperate. In some arrangements this replicated memory structure will be identical. Whilst in other arrangements this memory structure will have portions that are identical and other portions that are not. In still other arrangements the memory structures are different only in format or storage conventions such as Big Endian or Little Endian formats or conventions.

These structures and procedures when applied in combination when required, maintain a computing environment where the memory locations, address ranges, objects, classes, assets, resources, or any other procedural or structural aspect of a computer or computing environment are where required created, maintained, operated, and deactivated or deleted in a coordinated, coherent, and consistent manner across the plurality of individual machines M1, M2 . . . Mn.

Therefore the terminology “one”, “single”, and “common” application code or program includes the situation where all machines M1, M2 . . . Mn are operating or executing the same program or code and not different (and unrelated) programs, in other words copies or replicas of same or substantially the same application code are loaded onto each of the interoperating and connected machines or computers.

In conventional arrangements utilising distributed software, memory access from one machine's software to memory physically located on another machine typically takes place via the network interconnecting the machines. Thus, the local memory of each machine is able to be accessed by any other machine and can therefore cannot be said to be independent. However, because the read and/or write memory access to memory physically located on another computer require the use of the slow network interconnecting the computers, in these configurations such memory accesses can result in substantial delays in memory read/write processing operations, potentially of the order of 10⁶-10⁷ cycles of the central processing unit of the machine (given contemporary processor speeds). Ultimately this delay is dependent upon numerous factors, such as for example, the speed, bandwidth, and/or latency of the communication network. This in large part accounts for the diminished performance of the multiple interconnected machines in the prior art arrangement.

However, in the present arrangement all reading of memory locations or data is satisfied locally because a current value of all (or some subset of all) memory locations is stored on the machine carrying out the processing which generates the demand to read memory.

Similarly, all writing of memory locations or data is satisfied locally because a current value of all (or some subset of all) memory locations is stored on the machine carrying out the processing which generates the demand to write to memory.

Such local memory read and write processing operation can typically be satisfied within 10²-10³ cycles of the central processing unit. Thus, in practice there is substantially less waiting for memory accesses which involves and/or writes. Also, the local memory of each machine is not able to be accessed by any other machine and can therefore be said to be independent.

The arrangement is transport, network, and communications path independent, and does not depend on how the communication between machines or DRTs takes place. Even electronic mail (email) exchanges between machines or DRTs may suffice for the communications.

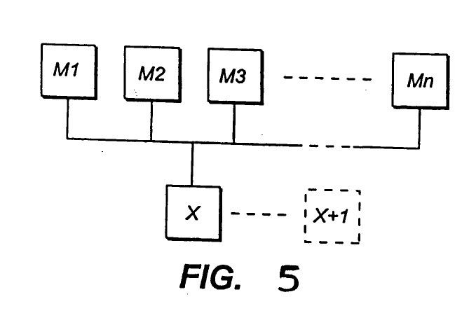

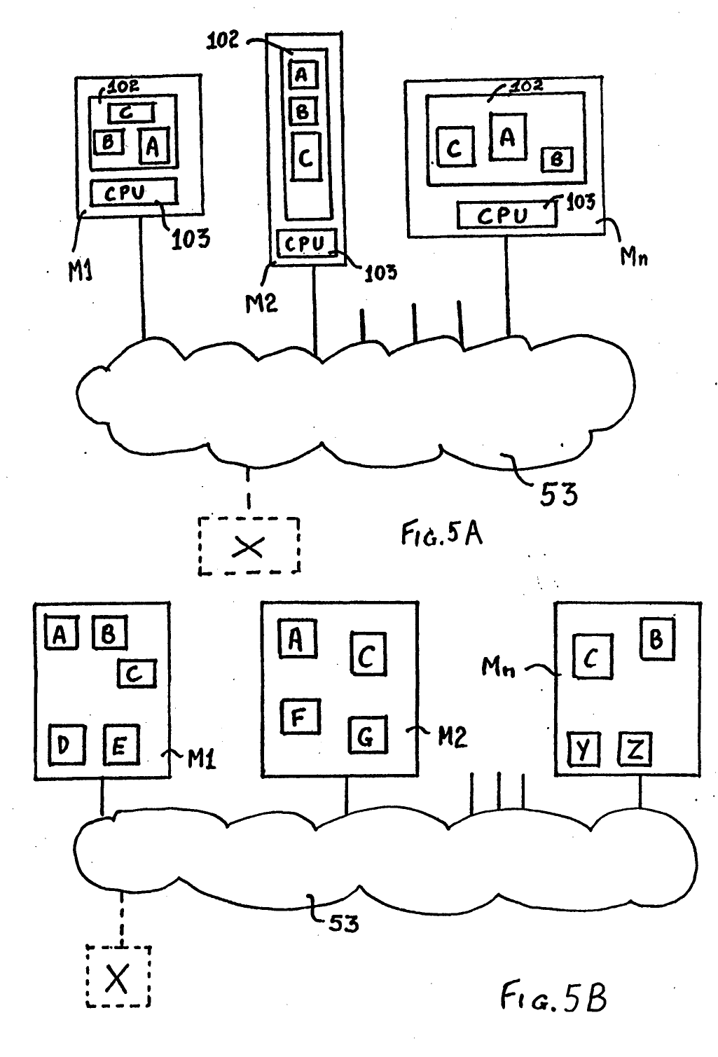

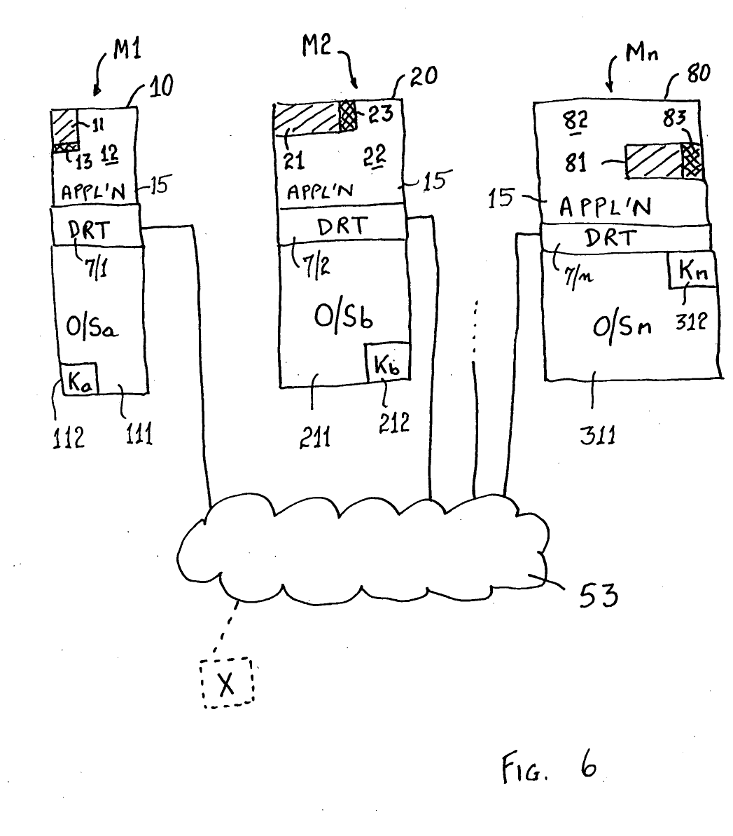

In connection with the above, it will be seen from FIG. 5 that there are a number of machines M1, M2, . . . Mn, “n” being an integer greater than or equal to two, on which the application program 50 of FIG. 4A is being run substantially simultaneously. These machines are allocated a number 1, 2, 3, . . . etc. in a hierarchical order. This order is normally looped or closed so that whilst machines 2 and 3 are hierarchically adjacent, so too are machines “n” and 1. There is preferably a further machine X which is provided to enable various housekeeping functions to be carried out, such as acting as a lock server. In particular, the further machine X can be a low value machine, and much less expensive than the other machines which can have desirable attributes such as processor speed. Furthermore, an additional low value machine (X+1) is preferably available to provide redundancy in case machine X should fail. Where two such server machines X and X+1 are provided, they are preferably, for reasons of simplicity, operated as dual machines in a cluster configuration. Machines X and X+1 could be operated as a multiple computer system in accordance with the abovedescribed arrangements, if desired. However this would result in generally undesirable complexity. If the machine X is not provided then its functions, such as housekeeping functions, are provided by one, or some, or all of the other machines.

FIG. 5A is a schematic diagram of a shared memory system. In FIG. 5A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exists three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 . . . Mn which each have a local replica of memory location A. This result is achieved of detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 5B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 50271 (to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative embodiments are also disclosed in the abovementioned specification.

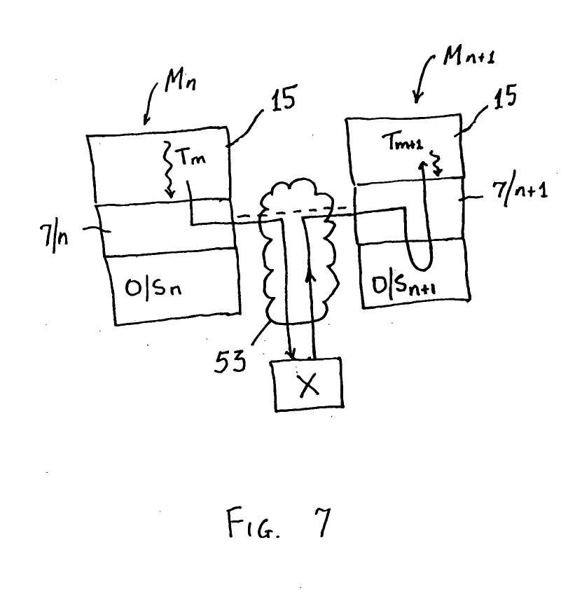

As seen in FIG. 6, the multiple computer system of the preferred embodiment consists of an integral number “n” of machines M1, M2, . . . Mn each of which, as schematically illustrated in FIG. 6, may be different in many senses. Firstly, the individual computers can be manufactured by different companies, can operate on different operating systems, and can include different kernels. Additionally, the independent local memories of each of the computers may be of different sizes/capacities. This is schematically illustrated in FIG. 6 by the different size of the computers 10, 20, . . . 80 and by the different operating systems O/Sa 111, O/Sb 211, . . . and O/Sn 311 together with corresponding kernels Ka 112, Kb 212, . . . Kn 312. Importantly, for each of the computers M1, M2, . . . Mn the combination of operating system and kernel is unmodified and thus each of the computers M1, M2, . . . Mn is a “trusted computing base”. If desired, a server machine X can also be provided. Since the server machine is not essential it is indicated in phantom in FIG. 6. All the machines M1-Mn, and X if present, are interconnected via a commodity communications network 53.

Furthermore, on each of the computers M1, M2, . . . Mn the same application program 15 is loaded in part or in its entirety. The application program 15 differs from the application program 5 of FIG. 1 only in that various modifications are made either before, and/or during and/or immediately after the loading of the application program. As explained in the abovementioned incorporated by cross-reference specifications, these modifications are carried out automatically by the distributed run time (DRT) 7/1, 7/2, . . . 7/n.

Additionally, within the application memories 12, 22, . . . 82, is indicated a replicated application memory region 11, 21, . . . 81, and a non-replicated application memory region 13,23, . . . 83 respectively. Preferably such non-replicated application memory regions 13,23, . . . 83 comprise thread-local storage (such as thread-private data structures and memory) for any/all threads operating on the local machine (that is, machines M1, M2, . . . Mn, Mn+1 respectively). Preferably such replicated application memory regions 11, 21, . . . 81 comprise application memory locations/contents/values which are replicated on each of the machines M1, M2 . . . Mn, Mn+1 and updated to remain substantially similar. Additionally, such replicated application memory regions may also comprise partially replicated application memory locations/contents/values which are replicated on some subset of machines M1, M2, . . . Mn, Mn+1.

In the arrangement of FIG. 6 the DRT intercepts any new thread which is created (and not the kernels), or requested to be created by the application program. Therefore it is no longer necessary for each kernel to keep track of each thread. Instead each kernel only keeps track of the threads running on its machine. Thus the kernels are not modified and the entire operating system O/S of each machine can be off the shelf, unmodified (and if desired different). Thus the operating system and kernel of each of the machines M1-Mn remains intact, and therefore remains an uncompromised/unaltered “trusted computing base”.

In the multiple computer environment of the preferred embodiment, as illustrated in FIG. 7, two machines Mn and Mn+1 are simultaneously operating different portions of the same application program 15 which has been loaded onto, and is operating on, each of the multiple computers. As before the multiple computers are interconnected by means of a communications network 53. In the event that the portion of the application program 15 which is executing on machine Mn wishes to create a new thread, then that portion of the application program includes the instruction “new thread ( )”. The intention of the original programmer of the application program 15 was that in addition to having the thread Tm available for execution of the application program, an additional thread Tm+1 should be created to be available for execution. However, instead of this additional thread Tm+1 being created on the same machine, in accordance with the preferred embodiment of the present invention the additional thread Tm+1 is created on a different machine, in this example machine Mn+1.

This change in circumstance is brought about by the DRT 71/n of machine Mn intercepting or detecting the JAVA instruction “new thread ( )”. Instead of this instruction reaching the operating system O/Sn of machine Mn, the DRT 71/n intercepts the instruction or operation to create a new thread and sends a request for a new thread to be created on a remote machine to the server machine X. The server machine X thus alerted routes the request for an additional thread to a different machine Mn+1 and, in particular, to the DRT 71/n+1 of that different machine. The DRT 71/n+1 of the different machine then treats the request for the additional thread as if it had been generated by that portion of the application program 15 which is operating on machine Mn+1. As indicated schematically in FIG. 7, that request for an additional thread is passed to the operating system O/Sn+1 of machine Mn+1 which in turn creates the new thread Tm+1 on machine Mn+1.

This intervention of the DRT so as to create a new thread on a different machine has the consequence that the machine which commences execution of the application program 15 does not fill up with threads whilst the other machines of the system remain substantially idle. As indicated in FIG. 7 by means of a broken line, in the absence of a server machine X then the instruction from DRT 71/n can be routed directly to the DRT 71/n+1. However, an advantage of the server machine is that the server machine is able to keep track of the total number of threads created on each of the multiple machines.

As the application memory locations/contents are replicated between the plural machines, the additionally created thread Tm+1 is able to be executed on any of the plural computers by accessing the replicated application memory locations/contents necessary for the operation of thread Tm+1. Specifically, when an application program creates a new thread, such newly created thread is to utilise upon its execution one or more application objects, memory locations, methods, or other memory or executable code of the application program. In multiple computer systems operating as a replicated shared memory arrangement where application memory locations/contents (such as for example objects, classes, fields, arrays, and the like, as well as methods, and executable code and the like) are replicated across the plural machines, the replication of application memory locations/contents makes it possible to allocate any thread of the application program on potentially any computer of the replicated shared memory arrangement, as the application memory locations/contents (such as for example objects, classes, memory locations, methods, and the like, as well as methods, and executable code and the like) required for the operation of such thread(s) are replicated across the plural machines.

If the multiple computer system has, for example, sixteen machines which for convenience can be numbered M0, M1, M2, . . . M14, M15 then these machines can be regarded as being numbered in a hierarchical order in a closed sequential loop with M15 and M0 being adjacent members of the looped sequence. Thus a simple and convenient way of designating the machine which should be the one to have the new thread created, is to create the new thread on a machine which is one higher in number (that is upwardly adjacent) than the machine which requested the new thread. That is, for example, if machine M7 is to request a new thread then the new thread is created on machine M8, with the understanding that if machine M15 requests a new thread then the new thread is created on machine M0. In this way, any portion of the application program 15 which during execution desires that a new thread is created, results in the new thread being created in the adjacent machine. Since each newly created thread is allocated to the next machine along in the sequence of machines, the threads will be substantially evenly distributed amongst all the machines in the multiple computer system. As a result, such a system achieves a reasonably balanced distribution of application threads across the plural machines.

In addition, it is possible to create a thread “in advance” of it being allocated a computing task by the application program. Such a thread can be created in machine Mn+1 and only commences operation when the computing task is allocated by the application program. Consequently, the new thread may be created/allocated in machine Mn+1 ahead of the application request to create a thread, and held there until a computing task is allocated by the application program and instructed to commenced. Such an arrangement is preferable as the latency and computational overhead of creating a thread on a remote machine is incurred prior to a request to create a thread by the application program, thereby appearing to speed up the operation of the application program operating on the multiple computer system. However, when such an arrangement as this is used, then the load on the various machines may have changed significantly in the time between the creation of the new thread and it commencing its allocated computational tasks by the application program.

To summarize, there is disclosed in a multiple computer environment in which a plurality of computers each having an independent local memory, are each able to execute a different portion of an application program written to be executed on only a single computer and are each interconnected by means of a communications network, the improvement comprising the steps of:

(i) intercepting or detecting an instruction or operation to create an additional thread about to be executed by the portion of the application program executing on one of the computers,
(ii) preventing the one computer from creating the additional thread,
(iii) instructing another one of the plurality of computers to create the additional thread, and
(iv) creating the additional thread on the another computer.

Preferably the method includes the further step of:

(v) passing the thread creating instruction or request directly from the one computer to the another computer.

Preferably the method includes the further step of:

(vi) passing the thread creating instruction or request from the one computer to a server computer, and
(vii) passing the thread creating instruction or request from the server computer to the another computer.

Preferably each of the plurality of computers is numbered and forms a closed sequential loop, the method comprising the step of:

(viii) arranging for the another computer to be that computer which is adjacent the one computer in the loop.

Preferably at least one application memory location or content is replicated in at least some of the independent memories and is/are updated to remain substantially similar.

Preferably the method includes the steps of:

(ix) commencing execution of the additional thread n the another computer.

Preferably the method includes the further step of:

(x) the additional thread utilizing during execution the replicated application memory or contents of the another computer.

Also disclosed is a multiple computer system in which a plurality of computers each having an independent local memory, and each being able to execute a different portion of the same application program written to be executed on only a single computer, the plurality of computers each being interconnected via a communications network, wherein each the computer includes intercepting or detecting means to intercept or detect an instruction to create an additional thread about to be executed by the portion of the application program executing on that computer and prevent the additional thread from being created on that computer, and each the computer includes routing means to pass the thread creating instruction to another one of the plurality of computers on which the additional thread is created.

Preferably the routing means passes the thread creating instruction or request directly to the another computer.

Preferably the routing means passes the thread creating instruction or request to a server computer which identifies the another computer and passes the thread creating instruction or request thereto.

Preferably each of the plurality of computers is numbered and forms a closed sequential loop, the one computer and the another computer being adjacent computers in the loop.

Preferably at last one application memory or content is replicated on at least some of the independent local memories and updated to remain substantially similar.

Preferably the additional thread is executed by the another computer.

Preferably the replicated application memory or contents of the another computer are utilized during execution of the additional thread.

The foregoing describes only some embodiments of the present invention and modifications, obvious to those skilled in the art, can be made thereto without departing from the scope of the present invention. For example, reference to JAVA includes both the JAVA language and also JAVA platform and architecture.

In all described instances of modification, where the application code 50 is modified before, or during loading, or even after loading but before execution of the unmodified application code has commenced, it is to be understood that the modified application code is loaded in place of, and executed in place of, the unmodified application code subsequently to the modifications being performed.

Alternatively, in the instances where modification takes place after loading and after execution of the unmodified application code has commenced, it is to be understood that the unmodified application code may either be replaced with the modified application code in whole, corresponding to the modifications being performed, or alternatively, the unmodified application code may be replaced in part or incrementally as the modifications are performed incrementally on the executing unmodified application code. Regardless of which such modification routes are used, the modifications subsequent to being performed execute in place of the unmodified application code.

It is advantageous to use a global identifier is as a form of ‘meta-name’ or ‘meta-identity’ for all the similar equivalent local objects (or classes, or assets or resources or the like) on each one of the plurality of machines M1, M2 . . . Mn. For example, rather than having to keep track of each unique local name or identity of each similar equivalent local object on each machine of the plurality of similar equivalent objects, one may instead define or use a global name corresponding to the plurality of similar equivalent objects on each machine (e.g. “globalname7787”), and with the understanding that each machine relates the global name to a specific local name or object (e.g. “globalname7787” corresponds to object “localobject456” on machine M1, and “globalname7787” corresponds to object “localobject885” on machine M2, and “globalname7787” corresponds to object “localobject111” on machine M3, and so forth).

It will also be apparent to those skilled in the art in light of the detailed description provided herein that in a table or list or other data structure created by each DRT 71 when initially recording or creating the list of all, or some subset of all objects (e.g. memory locations or fields), for each such recorded object on each machine M1, M2 . . . Mn there is a name or identity which is common or similar on each of the machines M1, M2 . . . Mn. However, in the individual machines the local object corresponding to a given name or identity will or may vary over time since each machine may, and generally will, store memory values or contents at different memory locations according to its own internal processes. Thus the table, or list, or other data structure in each of the DRTs will have, in general, different local memory locations corresponding to a single memory name or identity, but each global “memory name” or identity will have the same “memory value or content” stored in the different local memory locations. So for each global name there will be a family of corresponding independent local memory locations with one family member in each of the computers. Although the local memory name may differ, the asset, object, location etc has essentially the same content or value. So the family is coherent.

The term “table” or “tabulation” as used herein is intended to embrace any list or organised data structure of whatever format and within which data can be stored and read out in an ordered fashion.

It will also be apparent to those skilled in the art in light of the description provided herein that the abovementioned modification of the application program code 50 during loading can be accomplished in many ways or by a variety of means. These ways or means include, but are not limited to at least the following five ways and variations or combinations of these five, including by:
(i) re-compilation at loading,
(ii) a pre-compilation procedure prior to loading,
(iii) compilation prior to loading,
(iv) “just-in-time” compilation(s), or
(v) re-compilation after loading (but, for example, before execution of the relevant or corresponding application code in a distributed environment).

Traditionally the term “compilation” implies a change in code or language, for example, from source to object code or one language to another. Clearly the use of the term “compilation” (and its grammatical equivalents) in the present specification is not so restricted and can also include or embrace modifications within the same code or language.

Those skilled in the computer and/or programming arts will be aware that when additional code or instructions is/are inserted into an existing code or instruction set to modify same, the existing code or instruction set may well require further modification (such as for example, by re-numbering of sequential instructions) so that offsets, branching, attributes, mark up and the like are properly handled or catered for.

Similarly, in the JAVA language memory locations include, for example, both fields and array types. The above description deals with fields and the changes required for array types are essentially the same mutatis mutandis. The above is equally applicable to similar programming languages (including procedural, declarative and object orientated languages) to JAVA including Microsoft.NET platform and architecture (Visual Basic, Visual C/C++, and C#) FORTRAN, C/C++, COBOL, BASIC etc.

The terms object and class used herein are derived from the JAVA environment and are intended to embrace similar terms derived from different environments such as dynamically linked libraries (DLL), or object code packages, or function unit or memory locations.

The above arrangements may be implemented by computer program code statements or instructions (possibly including by a plurality of computer program code statements or instructions) that execute within computer logic circuits, processors, ASICs, logic or electronic circuit hardware, microprocessors, microcontrollers or other logic to modify the operation of such logic or circuits to accomplish the recited operation or function. In another arrangement, the implementation may be in firmware and in other arrangements may be implemented in hardware. Furthermore, any one or each of these various be implementation may be a combination of computer program software, firmware, and/or hardware.

Any and each of the abovedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer in which it executes or on a computer coupled with, connected to, or otherwise in signal communications with the computer on which the computer program or computer program product is present or executing. Such a computer program or computer program product modifies the operation and architectural structure of the computer, computing machine, and/or information appliance to alter the technical operation of the computer and realize the technical effects described herein.

The invention may therefore be constituted a computer program product comprising a set of program instructions stored in a storage medium or existing electronically in any form and operable to permit a plurality of computers to carry out any of the methods, procedures, routines, or the like as described herein including in any of the claims.

Furthermore, the invention includes (but is not limited to) a plurality of computers, or a single computer adapted to interact with a plurality of computers, interconnected via a communication network or other communications link or path and each operable to substantially simultaneously or concurrently execute the same or a different portion of an application code written to operate on only a single computer on a corresponding different one of computers. The computers are programmed to carry out any of the methods, procedures, or routines described in the specification or set forth in any of the claims, on being loaded with a computer program product or upon subsequent instruction. Similarly, the invention also includes within its scope a single computer arranged to co-operate with like, or substantially similar, computers to form a multiple computer system

The term “distributed runtime system”, “distributed runtime”, or “DRT” and such similar terms used herein are intended to capture or include within their scope any application support system (potentially of hardware, or firmware, or software, or combination and potentially comprising code, or data, or operations or combination) to facilitate, enable, and/or otherwise support the operation of an application program written for a single machine (e.g. written for a single logical shared-memory machine) to instead operate on a multiple computer system with independent local memories and operating in a replicated shared memory arrangement. Such DRT or other “application support software” may take many forms, including being either partially or completely implemented in hardware, firmware, software, or various combinations therein.

The methods of this invention described herein are preferably implemented in such an application support system, such as DRT described in International Patent Application No. PCT/AU2005/000580 published under WO 2005/103926 (and to which US Patent Application No. 111/111,946 Attorney Code 5027F-US corresponds), however this is not a requirement of this invention. Alternatively, an implementation of the methods of this invention may comprise a functional or effective application support system (such as a DRT described in the abovementioned PCT specification) either in isolation, or in combination with other softwares, hardwares, firmwares, or other methods of any of the above incorporated specifications, or combinations therein.

The reader is directed to the abovementioned PCT specification for a full description, explanation and examples of a distributed runtime system (DRT) generally, and more specifically a distributed runtime system for the modification of application program code suitable for operation on a multiple computer system with independent local memories functioning as a replicated shared memory arrangement, and the subsequent operation of such modified application program code on such multiple computer system with independent local memories operating as a replicated shared memory arrangement.

Also, the reader is directed to the abovementioned PCT specification for further explanation, examples, and description of various methods and means which may be used to modify application program code during loading or at other times.

Also, the reader is directed to the abovementioned PCT specification for further explanation, examples, and description of various methods and means which may be used to modify application program code suitable for operation on a multiple computer system with independent local memories and operating as a replicated shared memory arrangement.

Finally, the reader is directed to the abovementioned PCT specification for further explanation, examples, and description of various methods and means which may be used to operate replicated memories of a replicated shared memory arrangement, such as updating of replicated memories when one of such replicated memories is written-to or modified.

In alternative multicomputer arrangements, such as distributed shared memory arrangements and more general distributed computing arrangements, the above described methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the methods are applicable. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 6).

Alternatively or in combination, it is also further provided and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further provided and envisaged that any of the described functions or operations described as being performed by an optional server machine X (or multiple optional server machines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

The terms “object” and “class” used herein are derived from the JAVA environment and are intended to embrace similar terms derived from different environments, such as modules, components, packages, structs, libraries, and the like.

The use of the term “object” and “class” used herein is intended to embrace any association of one or more memory locations. Specifically for example, the term “object” and “class” is intended to include within its scope any association of plural memory locations, such as a related set of memory locations (such as, one or more memory locations comprising an array data structure, one or more memory locations comprising a struct, one or more memory locations comprising a related set of variables, or the like).

In the JAVA language memory locations include, for example, both fields and elements of array data structures. The above description deals with fields and the changes required for array data structures are essentially the same mutatis mutandis.

Any and all embodiments of the present invention are able to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments such may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

For ease of description, some or all of the indicated memory locations herein may be indicated or described to be replicated on each machine (as shown in FIG. 5A), and therefore, replica memory updates to any of the replicated memory locations by one machine, will be transmitted/sent to all other machines. Importantly, the methods and embodiments of this invention are not restricted to wholly replicated memory arrangements, but are also applicable to and operable for partially replicated shared memory arrangements mutatis mutandis (e.g. where one or more memory locations are only replicated on a subset of a plurality of machines, such as shown in FIG. 5B).

The term “comprising” (and its grammatical variations) as used herein is used in the inclusive sense of “having” or “including” and not in the exclusive sense of “consisting only of”.

I/We claim:

1. In a multiple computer environment in which a plurality of computers each having an independent local memory, are each able to execute a different portion of an application program written to be executed on only a single computer and are each interconnected by means of a communications network, a method of controlling the creation of a thread by a portion of said application program wherein an improvement to the method comprising the steps of:
(i) intercepting or detecting an instruction or operation to create an additional thread about to be executed by the portion of said application program executing on one of said computers;
(ii) preventing said one computer from creating said additional thread;
(iii) instructing another one of said plurality of computers to create said additional thread; and
(iv) creating said additional thread on said another computer.

2. The method as in claim 1, including the further step of:
(v) passing said thread creating instruction directly from said one computer to said another computer.

3. The method as in claim 1, including the further step of:
(vi) passing said thread creating instruction from said one computer to a server computer; and
(vii) passing said thread creating instruction from said server computer to said another computer.

4. The method as in claim 1, wherein each of said plurality of computers is numbered and forms a closed sequential loop, said method further comprising the step of:
(viii) arranging for said another computer to be that computer which is adjacent said one computer in said loop.

5. A computer program stored in a computer readable media, the computer program adapted for execution in a processor within a computer or information appliance and a memory coupled with the processor to modify the operation of the computer or information appliance, for modifying the operation of the computer or information appliance in a multiple computer environment in which a plurality of computers each having an independent local memory, are each able to execute a different portion of an application program written to be executed on only a single computer and are each interconnected by means of a communications network, the modification including performing a method of controlling the creation of a thread by a portion of said application program, said method comprising:
(i) intercepting or detecting an instruction or operation to create an additional thread about to be executed by the portion of said application program executing on one of said computers;
(ii) preventing said one computer from creating said additional thread;
(iii) instructing another one of said plurality of computers to create said additional thread; and
(iv) creating said additional thread on said another computer.

6. The computer program product as in claim 5, wherein the method including the further step of:
(v) passing said thread creating instruction directly from said one computer to said another computer.

7. The computer program product as in claim 5, wherein the method including the further step of:
(vi) passing said thread creating instruction from said one computer to a server computer; and
(vii) passing said thread creating instruction from said server computer to said another computer.

8. The computer program product as in claim 7, wherein the method further including numbering or identifying each of said plurality of computers so that said plurality of computers are numbered and form a closed sequential loop, and said method further comprising the step of:
(viii) arranging for said another computer to be that computer which is adjacent said one computer in said loop.

9. A multiple computer system comprising:
a plurality of computers in which each of said plurality of computers has an independent local memory, each of said plurality of local computers being interconnected via a communications network;
each of said plurality of local computers comprising:
means for executing a different portion of an application program written to be executed on only a single conventional computer;
intercepting or detecting means for intercepting or detecting an instruction to create an additional thread that is about to be executed by the portion of said application program executing on that particular local computer and for preventing said additional thread from being created on that particular local computer,
routing means for passing said thread creating instruction to another one of said plurality of local computers on which said additional thread is created.

10. The system as in claim 9, wherein said routing means passes said thread creating instruction directly to said another local computer.

11. The system as in claim 9, wherein said routing means passes said thread creating instruction to a server computer which identifies said another local computer and passes said thread creating instruction thereto.

12. The system as in claim 9, wherein each of said plurality of local computers is numbered and forms a closed sequential loop, said one computer and said another computer being adjacent computers in said loop.

13. A method of scheduling jobs among a plurality of computers operating in a multiple computer system, the method comprising:
(i) detecting an intended operation by at least one of said plurality of computers to create or schedule a job associated with executed by the portion of an application program on one of said plurality of computers;
(ii) preventing said at least one computer from creating said additional job;
(iii) instructing another one of said plurality of computers to create or schedule said job; and
(iv) creating said job on said another computer.
